(19) United States
(12) Patent Application Publication
(10) Pub. No.: US 2022/0033054 A1
(43) Pub. Date: Feb. 3, 2022

(54) HYBRID RAIL FOR AN AIRCRAFT FLOOR

(71) Applicants: Airbus Operations (S.A.S.), Toulouse (FR); Airbus Operations GmbH, Hamburg (DE)

(72) Inventors: Armin Fangmeier, Hamburg (DE); Giuseppe Vassilakakis, Toulouse (FR)

(73) Assignees: Airbus Operations (S.A.S.), Toulouse (FR); Airbus Operations GmbH, Hamburg (DE)

(21) Appl. No.: 17/360,102

(22) Filed: Jun. 28, 2021

(30) Foreign Application Priority Data
Jun. 29, 2020 (FR) 2006798

(51) Int. Cl. B64C 1/20; B64D 11/06

(52) U.S. Cl. CPC B64C 1/20; B64D 11/0696

(57) ABSTRACT

A rail for an aircraft floor includes an upper plate for supporting a set of floor panels covering the plate, and a lower stiffening structure. The rail is formed by a beam and by an anticorrosion protection. The beam is at least formed by a body made of a first material and defining the lower stiffening structure and an upper platform. The anticorrosion protection fully covers an upper face of the upper platform and forms therewith the upper plate of the rail, thus layered. The anticorrosion protection is at least formed by a protective sheet made of a second material that is more corrosion resistant than the first material and is selected from a metal and a fiber-reinforced plastic composite material. Such a rail exhibits good corrosion resistance at a moderate cost.

### CROSS-REFERENCE TO RELATED APPLICATION

This application claims priority to French patent application number 20 06798 filed on Jun. 29, 2020, the entire disclosure of which is incorporated by reference herein.

### TECHNICAL HELD

The disclosure herein relates to a rail for an aircraft floor, of the type comprising an upper plate intended to support a set of floor panels, and a lower stiffening structure connected to the upper plate. Such a rail, which is not used for fixing seats but is only used to support floor panels, is sometimes called “dummy rail”, In the event that such a rail has, in addition to one or more common regions, the purpose of which is to support floor panels like a dummy rail, one or more reinforced regions adapted for fixing cabin structures (furnishings, partition walls), the rail is sometimes called “galley rail”.

### BACKGROUND

Inside aircraft, the rails of the floors are subject to corrosion phenomena due to the presence of air and moisture in their environment.

Unlike the seat fixing rails, which have been optimized for better corrosion resistance, the dummy rails and galley rails, which are considered to be less critical and which generally have simpler shapes, have not benefitted from such optimizations. The anticorrosion protection of such rails thus has been limited to coating the rails with a silicon layer, which is an easily scratched soft material, or by a layer of paint, which by nature is very thin (typically approximately 100 microns). In both cases, the anticorrosion protection that is provided therefore proves to be limited over time. Thus, only the selection of a particularly corrosion resistant material as a constituent material of such rails has allowed the durable corrosion resistance of these rails to be improved, but at considerable additional expense.

### SUMMARY

The subject matter of the disclosure herein is a rail of the aforementioned type that exhibits good corrosion resistance that is durable over time, while having a limited cost.

To this end, the subject matter herein discloses a rail for an aircraft floor, comprising an upper plate intended to support a set of floor panels covering the plate, and a lower stiffening structure connected to the upper plate, wherein it is formed by:
a beam, at least formed by a body made of a first material and defining the lower stiffening structure and an upper platform; and
an anticorrosion protection fully covering an upper face of the upper platform, whereby the anticorrosion protection and the upper platform together form the upper plate of the rail, the anticorrosion protection being at least formed by a protective sheet made of a second material that is more corrosion resistant than the first material.

The configuration of the anticorrosion protection enables effective and durable anticorrosion protection of the rail, whilst allowing the overall cost of the rail to be limited.

Preferably, the first material is aluminum or an aluminum alloy.

Preferably; the thickness of the protective sheet is greater than 0.2 mm; preferably greater than 0.3 mm, and even more preferably greater than 0.4 mm.

Preferably; the second material is selected from titanium or a titanium alloy, a stainless steel, and a plastic material.

Preferably, the upper platform of the beam and the anticorrosion protection have at least one pair of respective aligned holes jointly defining a through-passage extending through the upper plate of the rail for a fixing component.

Preferably; the rail comprises an anticorrosion protection bush at least housed in the hole of the upper platform of the beam and demarcating at least one segment of the through-passage.

Preferably, the anticorrosion protection bush is embedded in the upper platform and is covered by a piece of the anticorrosion protection forming a periphery of the hole of the anticorrosion protection.

As an alternative embodiment, the anticorrosion protection bush extends through the anticorrosion protection.

Preferably, the beam further comprises an anticorrosion coating that covers the whole of the body of the beam, whereby the anticorrosion coating is inserted between the body of the beam and the anticorrosion protection in the vicinity of the upper plate.

Preferably, the anticorrosion protection further comprises a bonding layer inserted between the protective sheet and the upper platform of the beam.

Preferably, the bonding layer is formed by at least one from among a mastic, a glue, and a double-sided tape.

Preferably, at least one lateral edge of the upper platform of the beam is protected against the penetration of corrosive fluids between the upper platform and the anticorrosion protection layer by a sealing agent disposed:
either in a space provided between the anticorrosion protection and the upper platform, since the lateral edge forms a curve at a junction with an upper face of the platform, or forms a curve over the whole of an edging strip of the platform;
or in the form of a deposit of material added onto a flat edging strip jointly formed by the lateral edge of the upper platform and a corresponding lateral edge of the anticorrosion protection;
or in the form of a deposit of material, which is added onto a flat edging strip at least formed by the lateral edge of the upper platform and which extends up to a lower face of a lateral edge of the protective sheet of the anticorrosion protection extending by overhanging beyond the flat edging strip.

The disclosure herein also relates to a floor for an aircraft, comprising a set of panels, and at least one rail of the type described above, the upper plate of which is covered by the set of panels.

The disclosure herein also relates to an aircraft, comprising at least one rail of the type described above or a floor of the type described above.

The disclosure herein also relates to a method for manufacturing a rail of the type described above for an aircraft floor, comprising the following steps:

A. providing the beam, at least formed by the body made of the first material and defining the lower stiffening structure and the upper platform;

B. providing the protective sheet made of the second material that is more corrosion resistant than the first material; then

C. fixing the protective sheet onto the upper platform so that the protective sheet fully covers the upper face of the upper platform.

### BRIEF DESCRIPTION OF THE DRAWINGS

The disclosure herein will be better understood, and further details, advantages and features thereof will become apparent from reading the following description, which is provided by way of a non-limiting example, and with reference to the accompanying drawings, in which:

FIG. 1 is a schematic side view of an aircraft;

FIG. 2 is a schematic perspective view of a known type of dummy rail;

FIG. 3 is a schematic perspective view of a known type of galley rail;

FIG. 4 is a schematic transverse section view of a dummy rail according to the disclosure herein;

FIG. 4A is a larger scale view of a part of FIG. 4;

FIG. 4B is a similar view to FIG. 4A illustrating an alternative embodiment of the disclosure herein;

FIG. 4C is a similar view to FIG. 4A illustrating another alternative embodiment of the disclosure herein;

FIG. 4D is a similar view to FIG. 4A illustrating yet another alternative embodiment of the disclosure herein;

FIG. 4E is a larger scale view of another part of FIG. 4;

FIG. 4F is a similar view to FIG. 4E illustrating an alternative embodiment of the disclosure herein;

FIG. 5 is a partial schematic transverse section view of an aircraft floor according to a first particular embodiment of the disclosure herein, particularly illustrating a dummy rail of this floor;

FIG. 5A is a larger scale view of a part of FIG. 5;

FIG. 6 is a partial schematic transverse section and perspective view of an aircraft floor according to a second particular embodiment of the disclosure herein, particularly illustrating a common region of a galley rail of this floor;

FIG. 7 is a partial schematic transverse section and perspective view of the aircraft floor according to the second embodiment of the disclosure herein, particularly illustrating a reinforced region of the galley rail;

FIG. 8 is a partial schematic transverse section and perspective view of an aircraft floor according to a third particular embodiment of the disclosure herein, particularly illustrating a common region of a galley rail of this floor;

FIG. 9 is a partial schematic transverse section view of the aircraft floor according to the third embodiment of the disclosure herein, particularly illustrating a reinforced region of the galley rail.

Throughout all these figures, identical reference signs can denote identical or similar elements.

### DETAILED DESCRIPTION

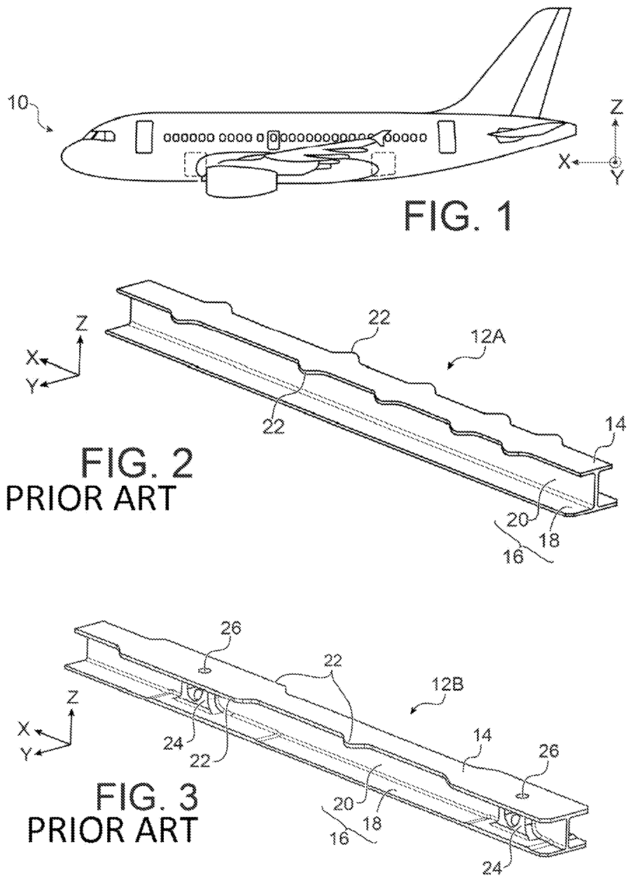

FIG. 1 illustrates an aircraft 10, for example, an aeroplane of the type intended for commercial passenger or freight transportation, comprising a floor formed by a set of floor panels resting on a structure formed by a set of rails and of crossbeams. Some of the rails, called “dummy rails” and “galley rails”, are not used to fix seats and have an upper plate covered by the set of floor panels, which the upper plate supports, and a lower stiffening structure connected to the upper plate. Covering such an upper plate with the set of floor panels generally means that the plate has a flat upper surface.

In the present description, the vertical direction Z, the “upper” and “lower” sides, as well as the “high” and “low” directions, are conventionally defined with reference to the orientation of the aircraft when the aircraft is on the ground. The directions X and Y are oriented orthogonal to the vertical direction Z so as to define an orthonormal coordinate system. In particular, the direction X is defined as the longitudinal direction of the rails, and the direction Y is defined as the transverse direction.

FIGS. 2 and 3 respectively illustrate a dummy rail 12A and a galley rail 12B, according to known configurations. These figures show the upper plate 14 intended to support one or more floor panel(s), and the lower stiffening structure 16, of each of the rails 12A and 12B. This stiffening structure generally comprises a heel 18 extending parallel to the upper plate 14 and a core 20 extending orthogonal to the upper plate 14 and to the heel 18 and connecting these two elements together. Each of the rails 12A and 12B typically comprises lugs 22 extending laterally by projecting from the upper plate 14 in order to accommodate components for fixing floor panels. The galley rail 12B has reinforced regions 24, housing, for example, barrel nuts each intended to accommodate, for example, via a corresponding hole 26 formed in the upper plate 14, a component for fixing a structure, such as a galley stand or a partition wall.

Such dummy rails and galley rails are normally made of aluminum covered with an anticorrosion coating assuming the form of a thin layer of paint or of a thick layer of relatively soft silicon. However, such a coating proves to be relatively fragile, in particular it is easy to scratch, and consequently is of limited effectiveness over time, such that significant costs are generated by the need to regularly replace such rails.

In order to overcome this problem, it has been proposed for such rails to be made of titanium in order to increase their corrosion resistance. However, such a change of material involves a considerable additional expense.

The disclosure herein that will now be described proposes a solution allowing good corrosion resistance while keeping costs low.

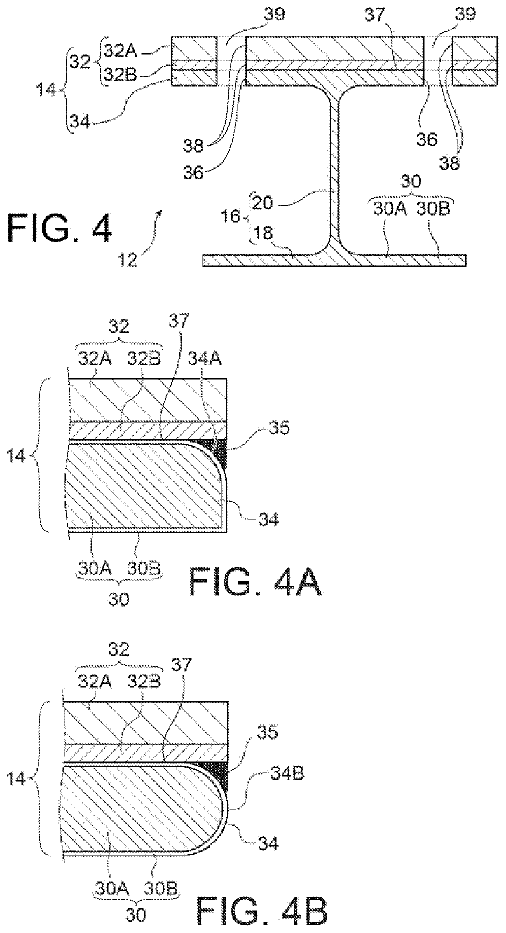

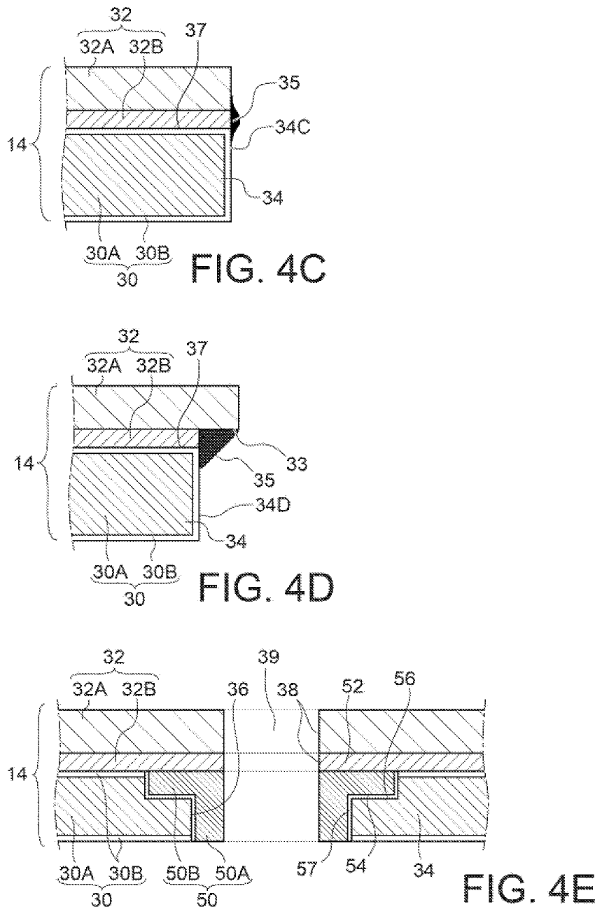

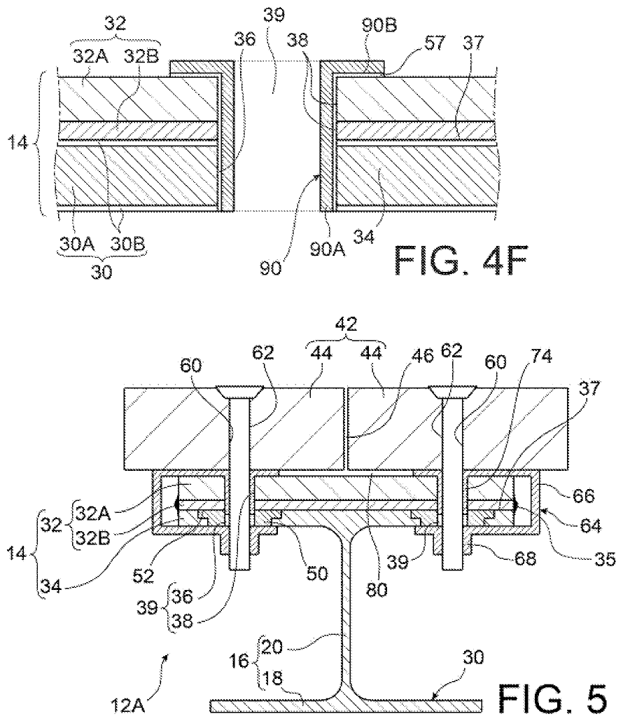

According to its most general aspect, with reference to FIG. 4, the disclosure herein proposes a rail 12 having, like the rails described above, an upper plate 14 intended to support one or more floor panel(s) covering the upper plate, and a lower stiffening structure 16 connected to the upper plate 14 and, for example, similar to that described with reference to FIGS. 2 and 3.

According to the disclosure herein, such a rail 12 is formed by a beam 30 and by an anticorrosion protection 32 such that;
the beam 30 defines the lower stiffening structure 16 and an upper platform 34 connected to the lower stiffening structure 16;
the beam 30 is at least formed by a body 30A made of a first material and defining the lower stiffening structure 16 and the upper platform 34;
the anticorrosion protection 32 fully covers an upper face 37 of the upper platform 34, whereby the anticorrosion protection 32 and the upper platform 34 together form the upper plate 14 of the rail;
the anticorrosion protection 32 is at least formed by a protective sheet 32A made of a second material that is more corrosion resistant than the first material.

This layered configuration of the upper plate 14, comprising at least the upper platform 34 and the protective sheet 32A in a stacked state, provides effective anticorrosion protection for the rail 12, while allowing the beam 30 to be made of a low-cost material. Indeed, it must be understood that a “protective sheet” is a relatively hard and rigid element that has been disposed on the upper platform 34, unlike the anticorrosion coatings of the prior art that are formed by silicon or by paint and that are obtained by deposits in the form of one or more flexible strip(s) or in the form of fluid on the rail, with the disadvantage of such coatings being that they are soft, in the case of silicon, or very thin, in the case of paint, as explained above.

The first material, from which the body 30A of the beam is made, is typically aluminum or an aluminum alloy.

The second material, from which the protective sheet 32A of the anticorrosion protection 32 is made, is advantageously made of a more “noble” metal, i.e. more corrosion resistant, than the first material, for example, of titanium or of a titanium alloy, or a stainless steel. In other embodiments, the second material is made of a plastic material, such as a plastic composite material made up of fiber s, preferably of glass fiber s, embedded in a hardened resin, or even a thermoplastic or thermosetting material.

Due to the use of two different materials, the corrosion resistance and cost properties of which are fully exploited, such a rail can be called “hybrid rail”.

The thickness of the protective sheet 32A preferably is greater than 0.2 mm, more preferably greater than 0.3 mm, and even more preferably greater than 0.4 mm.

In embodiments of the disclosure herein, with reference to FIG. 4, the beam 30 further comprises an anticorrosion coating 30B that covers the whole of the body 30A of the beam. With respect to the upper plate 14, it thus must be understood that, in such a case, the anticorrosion coating 30B is inserted between the body 30A of the beam and the anticorrosion protection 32. In such a case, the beam 30, formed by the body 30A and by the anticorrosion coating 30B, is therefore similar to a known type of rail.

Furthermore, in embodiments of the disclosure herein, still with reference to FIG. 4, the anticorrosion protection 32 further comprises a bonding layer 32B inserted between the protective sheet 32A and the upper platform 34 of the beam 30. The bonding layer 32B therefore is in contact with the anticorrosion coating 30B or, in embodiments that do not include this coating, in contact with the body 30A of the beam.

The bonding layer 32B ensures the adhesion of the protective sheet 32A to the upper platform 34 and is, to this end, advantageously formed by a mastic and/or a glue and/or a double-sided tape.

Furthermore; the protection of each lateral edge of the upper platform 34 of the beam 30, in particular against the penetration of corrosive fluids between the upper platform 34 and the anticorrosion protection layer 32, is advantageously provided by a sealing agent 35; such as a mastic or a glue; disposed:
either in a space provided between the anticorrosion protection 32 and the upper platform 34; since the lateral edge forms a curve 34A at the junction with the upper face of the platform (FIG. 4A), or forms a curve 34B over the whole of the edging strip of the platform (FIG. 43);
or in the form of a deposit of material (FIG. 4C) added onto a flat edging strip 34C jointly formed by the considered lateral edge of the upper platform 34 and a corresponding lateral edge of the anticorrosion protection 32;
or in the form of a deposit of material (FIG. 4D), which is added onto a flat edging strip 4D formed by the lateral edge of the upper platform 34 and, if applicable, by the bonding layer 32B of the anticorrosion protection 32, and which extends up to a lower face of a lateral edge 33 of the protective sheet 32A of the anticorrosion protection 32 extending by overhanging beyond the flat edging strip 34D.

As an alternative embodiment, the upper face 37 of the upper platform 34 can have lateral edges curved downwards to a lower face of the upper platform 34, in which case the anticorrosion protection layer 32 follows this curvature and thus intrinsically protects the sides of the upper platform.

In embodiments of the disclosure herein, with reference to FIG. 4, the upper platform 34 of the beam 30 and the anticorrosion protection 32 have one or more pairs of respective aligned holes 36, 38. Two pairs of holes of this type are thus shown in FIG. 4. The holes 36, 38 of each pair jointly define a through-passage 39 inside the upper plate 14 of the rail 12, allowing the passage of a fixing component (not shown in FIG. 4) intended, for example, to fix floor panels to the rail 12, or to fix structures to a floor comprising the rail 12, as will become more clearly apparent hereinafter.

With reference to FIGS. 4E and 4F, for each of the pairs of holes 36, 38, at least one segment of the through-passage 39, corresponding to the hole 36 of the upper platform 34, is advantageously demarcated by an anticorrosion protection bush housed in the hole 36 and preventing the first material making up the upper platform 34 from being exposed to corrosion in the vicinity of the internal surface of such a hole.

More specifically, FIG. 4E illustrates a configuration, called embedded bush configuration, in which such an anticorrosion protection bush, reference sign 50, is embedded in the upper platform 34 and covered by a piece 52 of the anticorrosion protection 32 forming a periphery of the corresponding hole 38 of the anticorrosion protection. In such a case, the anticorrosion protection bush 50 preferably has a lower portion 50A of rotationally cylindrical shape, and an upper rim 508, for example, of annular shape, laterally forming a projection relative to the lower portion 50A and defining a shoulder 54 between the lower portion 50A and the upper rim 50B. Furthermore, the upper platform 34 of the beam 30 has, around the corresponding hole 36, a counterbore 56, on which the shoulder 54 rests. Such a configuration allows the anticorrosion protection bush 50 to be retained in the corresponding hole 36, even in the absence of a fixing component in the corresponding through-passage 39.

FIG. 4F illustrates another configuration, called protruding bush configuration, in which the anticorrosion protection bush, reference sign 90, comprises a lower portion 90A, for example, of rotationally cylindrical shape, which extends through the anticorrosion protection 32, and an upper rim 908 applied on the anticorrosion protection 32.

In general, such an anticorrosion protection bush 50, 90 is made of a more corrosion resistant material than the first material, preferably of a metal material, for example, of titanium or a titanium alloy. The anticorrosion protection bush can, as an alternative embodiment, be made of polytetrafluoroethylene (PTFE) or of any other suitable material.

Moreover, mastic 57 (only shown in the large scale views of FIGS. 4E and 4F) is advantageously inserted between such a bush and the upper platform 34 of the beam 30, in the case of a bush in the embedded configuration, or between the bush and the assembly of the upper plate 14, in the case of a bush in the protruding configuration. The insertion of the mastic allows, if applicable, the phenomena of galvanic coupling between the anticorrosion protection bush 50, 90 and the upper platform 34 to be avoided.

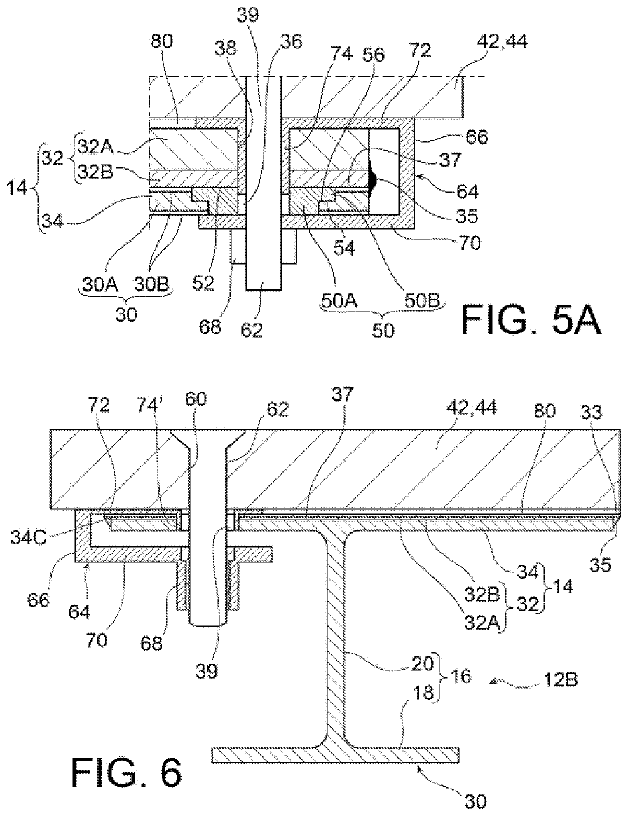

FIGS. 5 through 9 illustrate various examples of the use of the rail according to the disclosure herein.

FIG. 5 illustrates part of a floor 40 comprising at least one dummy rail 12A and a set 42 of floor panels 44, according to a first particular embodiment of the disclosure herein. FIG. 5 shows a configuration in which the dummy rail 12A is centred under the junction 46 between two adjacent floor panels 44.

In this embodiment, for each of the pairs of holes 36, 38 the hole 36 of the upper platform 34 of the beam 30 is demarcated by an anticorrosion protection bush 50 in an embedded configuration similar to that described above with reference to FIG. 4E.

The set 42 of floor panels 44 has through-holes 60 (two of which are shown in FIG. 5), which are respectively aligned with through-passages 39 of the upper plate 14 of the rail 12A, and which are respectively passed through by fixing screws, such as floor screws 62 fixing the floor panels 44 on the upper plate 14.

In embodiments of the disclosure herein like that of FIG. 5, the floor 42 comprises, for each floor screw 62, a snap-fitted suspension nut 64, also called “clip nut”. Such a nut 64 comprises a clip 66 shaped to clamp the upper plate 14 and to support a nut portion 68, into which the corresponding floor screw 62 is screwed.

To this end, with reference to FIG. 5A, the clip 66 has a section generally in the form of a “C” defining a lower tab 70 arranged under the upper plate 14 and supporting the nut portion 68 that extends downwards from a lower face of the lower tab 70, and an upper tab 72 arranged on the upper plate 14 and supporting a centring bush 74 extending downwards from the upper tab 72 while being engaged in the corresponding through-passage 39, optionally up to the anticorrosion protection bush 50.

By way of an example, a filling strip 80, for example, made up of a self-adhesive silicon foam, is also arranged on a region of the upper plate 14 that is not occupied by the upper tabs 72 of the nuts 64, so as to provide a level relative to the upper tabs 72 or, at the very least, to reduce the gap between the tabs and the upper surface of the upper plate 14. As an alternative embodiment or in addition, the floor panels 44 can deform so as to conform, with a certain degree of precision, to the profile created by the upper tabs 72 on the upper plate 14.

Furthermore, as an alternative embodiment, instead of the nut portion 68 being supported by a clip clamping the upper plate 14, the nut portion 68 can be supported by a bush forcibly inserted, from below, into the upper plate 14.

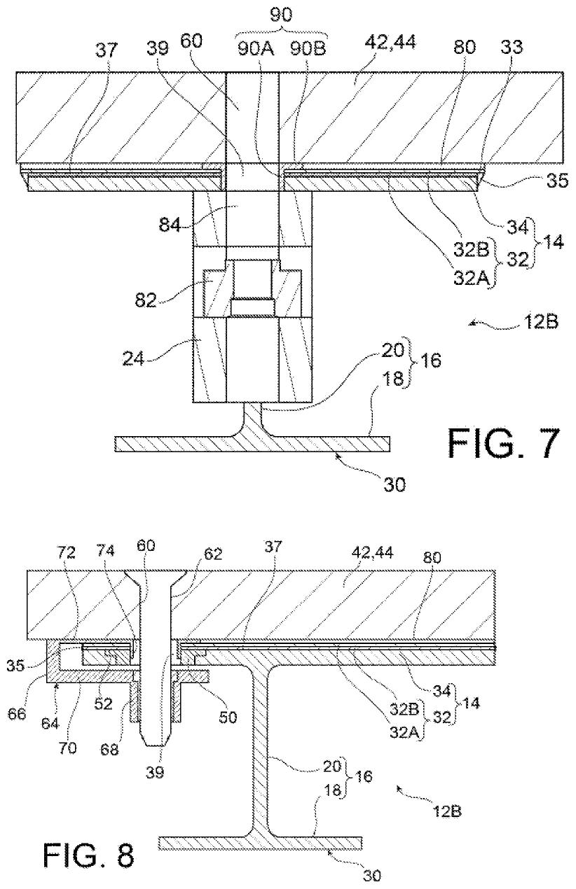

FIGS. 6 and 7 illustrate part of a floor 40 comprising at least one galley rail 12B, as well as a set 42 of floor panels 44 (one of which is shown in the figures), according to a second particular embodiment of the disclosure herein. These figures respectively show a common region of the rail (FIG. 6) and a reinforced region of the rail (FIG. 7). The main differences between this embodiment and that of FIGS. 5 and 5A will be described hereinafter.

In the illustrated example, a filling strip 80 is inserted between the upper plate 14 of the rail 12B and the set 42 of floor panels 44.

Furthermore, the protection of each lateral edge of the upper platform 34 of the beam 30 in this case is provided by depositing a sealing agent 35, as illustrated in FIG. 4D.

In this embodiment, the rail 12B does not comprise a bush embedded in the upper platform 34, like the anticorrosion protection bush 50 of FIGS. 5 and 5A.

However, the anticorrosion protection of the internal surface of each through-passage 39, intended to accommodate a floor screw 62 in a common region (FIG. 6) is provided by a centring bush 74′ of a snap-fitted suspension nut 64, with the centring bush 74′ extending from one end to the other of the through-passage 39 of the upper plate 14. Such a centring bush 74′ thus forms another example of an anticorrosion protection bush in the protruding configuration.

With respect to the reinforced region, FIG. 7 shows such a region, reference sign 24, made up of an over-thick portion of the core 20 housing a barrel nut 82. The reinforced region 24 defines a passage 84, in the extension of a corresponding through-passage 39 formed inside the upper plate 14, as explained above. Furthermore, the floor panel 44 has a through-hole 60 aligned with the through-passage 39 of the upper plate 14 and the passage 84 of the reinforced region 24, to allow the passage of a fixing component (not shown in the figure), such as a screw or a threaded rod, intended to fix a structure to the floor, by engaging with the barrel nut 82. In this example, the reinforced region 24 stops at a distance from the lower plate 18.

The anticorrosion protection of the internal surface of the through-passage 39 is provided by an anticorrosion protection bush 90 in a protruding configuration, as described above with reference to FIG. 4F. This bush 90 thus comprises a lower portion 90A extending from one end to the other of the through-passage 39 of the upper plate 14, and an upper rim 90B applied on the anticorrosion protection 32 and, if applicable, housed in a recess of the sealing strip 80, so that the corresponding floor panel 44 jointly rests on the sealing strip 80 and on the upper rim 90B.

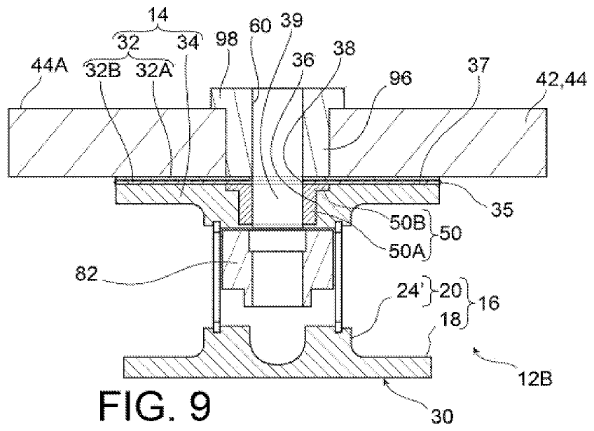

FIGS. 8 and 9 illustrate part of a floor 40 comprising at least one galley rail 123, as well as a set 42 of floor panels 44 (one of which is shown in the figures), according to a third particular embodiment of the disclosure herein. These figures respectively show a common part of the rail (FIG. 8) and a reinforced region of the rail (FIG. 9). The main differences between this third embodiment and the second embodiment (FIGS. 6 and 7) will be described hereinafter.

In this embodiment of FIGS. 8 and 9, the protection of each lateral edge of the upper platform 34 of the beam 30 is provided, for example, by a sealing agent 35 disposed as described above with reference to FIG. 4C.

Furthermore, each hole 36 of the upper platform 34 of the beam 30 is demarcated by an anticorrosion protection bush 50 embedded in the upper platform 34 and covered by a piece of the anticorrosion protection 32 forming a periphery 52 of the hole 38 of the anticorrosion protection, in the same way as in FIG. 4E.

The reinforced region 24′ of the rail 12B shown in FIG. 9 is defined by an over-thick portion of the core 20 forming a block connecting the lower plate 18 to the upper platform 34 and housing, for example, a barrel nut 82. This block connected to the upper platform 34 defines, together therewith, a through-hole 39 aligned with a through-hole 60 of the floor panel 44 for accommodating a fixing component (not shown in the figure) intended to fix a structure to the floor. The through-hole 39 is thus, in particular, defined by a pair of aligned holes 36, 38 comprising a hole 36 formed through the upper platform 34 and an upper part of the block making up the reinforced region 24′, and a hole 38 formed through the anticorrosion protection 32, in a similar manner to that which is described above. In this example, the through-hole 60 of the floor panel 44 is demarcated by a bush 96 having, for example, a rim 98 resting on an upper surface 44A of the floor panel 44.

In general, a method for manufacturing a rail 12, 12A, 12B for an aircraft floor of the type described above comprises the following steps:

A. providing the beam 30, at least formed by the body 30A made of the first material and defining the lower stiffening structure 16 and the upper platform 34;

B. providing the protective sheet 32A made of the second material that is more corrosion resistant than the first material; then

C. fixing the protective sheet 32A onto the upper platform 34 so that the protective sheet 32A fully covers the upper face 37 of the upper platform 34.

If applicable, step A comprises, after a sub-step a1 of providing the body 30A, a sub-step a2 of perforating holes 36 through the upper platform 34 (in this case, through the part of the body 30A initially forming the upper platform 34) and, if applicable, the formation of counterbores 56.

If applicable, step A subsequently comprises a sub-step a3 of anodizing the body 30A then/or a sub-step a4 of applying the anticorrosion coating 30B onto the body 30A (optionally after applying a primer thereto).

If applicable, step B comprises, after a sub-step b1 of providing the protective sheet 32A, a sub-step b2 of perforating holes 38 through the protective sheet 32A.

Step C comprises, for example, a sub-step c1 of depositing the bonding layer 32B onto the upper platform 34, in the form of fluid in the case whereby this bonding layer is formed by mastic or by glue, or in solid form in the case whereby this bonding layer is formed by double-sided tape.

In this case, step C subsequently comprises a sub-step C2 of depositing the protective sheet 32A onto the bonding layer 32B.

If applicable, step C comprises a sub-step c1 bis of placing one or more anticorrosion protection bush(es) 50, in the embedded bush configuration, in the holes 36 of the upper platform 34, before the sub-step c2.

If applicable, step C comprises, after the sub-step c2, a sub-step c3 of solidifying the bonding layer 32B.

Finally, if applicable, step C subsequently comprises a sub-step c4 of placing one or more anticorrosion protection bush(es) 90, in the protruding bush configuration, in the through-holes 39 of the upper plate 14.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A rail for an aircraft floor, comprising an upper plate to support a set of floor panels covering the plate, and a lower stiffening structure connected to the upper plate, wherein it is formed by:
a beam at least formed by a body made of a first material and defining the lower stiffening structure and an upper platform; and
an anticorrosion protection fully covering an upper face of the upper platform, whereby the anticorrosion protection and the upper platform together form the upper plate of the rail, the anticorrosion protection being at least formed by a protective sheet made of a second material that is more corrosion resistant than the first material.

2. The rail according to claim 1, wherein the first material is aluminum or an aluminum alloy.

3. The rail according to claim 1, wherein a thickness of the protective sheet is greater than 0.2 mm, greater than 0.3 mm, or greater than 0.4 mm.

4. The rail according to claim 1, wherein the second material is selected from the group consisting of titanium or a titanium alloy, a stainless steel, and a plastic material.

5. The rail according to claim 1, wherein the upper platform of the beam and the anticorrosion protection have at least one pair of respective aligned holes jointly defining a through-passage extending through the upper plate of the rail for a fixing component.

6. The rail according to claim 5, comprising an anticorrosion protection bush at least housed in a hole of the upper platform of the beam and demarcating at least one segment of the through-passage.

7. The rail according to claim 6, wherein the anticorrosion protection bush is embedded in the upper platform and is covered by a piece of the anticorrosion protection forming a periphery of the hole of the anticorrosion protection.

8. The rail according to claim 6, wherein the anticorrosion protection bush extends through the anticorrosion protection.

9. The rail according to claim 1, wherein the beam comprises an anticorrosion coating that covers a whole of the body of the beam, whereby the anticorrosion coating is inserted between the body of the beam and the anticorrosion protection in a vicinity of the upper plate.

10. The rail according to claim 1, wherein the anticorrosion protection further comprises a bonding layer inserted between the protective sheet and the upper platform of the beam.

11. The rail according to claim 10, wherein the bonding layer is formed by at least one of a mastic, a glue, and a double-sided tape.

12. The rail according to claim 1, wherein at least one lateral edge of the upper platform of the beam is protected against penetration of corrosive fluids between the upper platform and the anticorrosion protection layer by a sealing agent disposed:
either in a space provided between the anticorrosion protection and the upper platform, since the lateral edge forms a curve at a junction with an upper face of the platform, or forms a curve over a whole of an edging strip of the platform;
or in a form of a deposit of material added onto a flat edging strip jointly formed by the lateral edge of the upper platform and a corresponding lateral edge of the anticorrosion protection;
or in a form of a deposit of material, which is added onto a flat edging strip at least formed by the lateral edge of the upper platform and which extends up to a lower face of a lateral edge of the protective sheet of the anticorrosion protection extending by overhanging beyond the flat edging strip.

13. A floor for an aircraft, comprising a set of panels, and at least one rail according to claim 1, the upper plate of which is covered by the set of panels.

14. An aircraft comprising at least one rail according to claim 1.

15. An aircraft comprising a floor according to claim 13.

16. A method for manufacturing a rail for an aircraft floor, the rail comprising an upper plate to support a set of floor panels covering the plate, and a lower stiffening structure connected to the upper plate, wherein it is formed by:
a beam at least formed by a body made of a first material and defining the lower stiffening structure and an upper platform; and
an anticorrosion protection fully covering an upper face of the upper platform, whereby the anticorrosion protection and the upper platform together form the upper plate of the rail, the anticorrosion protection being at least formed by a protective sheet made of a second material that is more corrosion resistant than the first material.
the method comprising:
providing the beam, at least formed by the body made of the first material and defining the lower stiffening structure and the upper platform;
providing the protective sheet made of the second material that is more corrosion resistant than the first material; and
fixing the protective sheet onto the upper platform so that the protective sheet fully covers the upper face of the upper platform.
